(19) United States
(12) Patent Application Publication
(10) Pub. No.: US 2016/0241432 A1
(43) Pub. Date: Aug. 18, 2016

(54) SYSTEM AND METHOD FOR REMOTE CONFIGURATION OF NODES

(71) Applicant: Dell Products L.P., Round Rock, TX (US)

(72) Inventors: Sumanth Vidyadhara, Bangalore (IN); Rama Rao Bisa, Kandukur (IN); Chandrasekhar Puthillathe, Bangalore (IN); Jon Robert Hass, Austin, TX (US)

(21) Appl. No.: 14/624,286

(22) Filed: Feb. 17, 2015

(51) Int. Cl. H04L 12/24

(52) U.S. Cl. CPC H04L 41/0803

(57) ABSTRACT

A system comprises a first node, which comprises a first controller. The first controller is operable to access a set of files that are stored within a drive of the first node and configure the first node based on the set of files. The first controller is further configured to receive, from a second controller, a first message requesting access to the drive comprising the set of files. The second controller may be within a second node, which is different than the first node. In response to receiving the first message, the first controller transmits a second message to the second controller allowing the second controller to access the drive in the first node comprising the set of files by emulating the partition to configure the second node. The first controller is further configured to transfer the set of files to the second controller after transmitting the second message.

### TECHNICAL FIELD

This disclosure relates generally to information handling system, and relates more particularly to a system and method for remote configuration of nodes.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. For example, an information handling system may be a tablet computer, a mobile device (e.g., personal digital assistant (PDA) or smart phone), or an enterprise server configured to transmit data on a wireless communications network. Information handling systems may include a variety of hardware and software components that may be configured to process, store, and communicate information and may include one or more computer systems, data storage systems, and networking systems.

Certain information handling systems require flash storage space to perform management tasks. As space constraints increase in information handling systems, certain issues and problems may arise with providing sufficient flash storage space.

### SUMMARY

According to embodiments of the present disclosure, a system comprises a first node and the first node comprises a first controller. The first controller is operable to access a set of files that are stored within a drive of the first node and configure the first node based on the set of files. The first controller is further configured to receive, from a second controller, a first message requesting access to the partition in the first node comprising the set of files. The second controller may be within a second node, which is different than the first node. In response to receiving the first message, the first controller transmits a second message to the second controller allowing the second controller to access the partition in the first node comprising the set of files by emulating the partition to configure the second node. The first controller is further configured to transfer the set of files to the second controller.

Certain embodiments of the present disclosure may provide one or more technical advantages. For example, by allowing access to the set of files stored on the first node, the second node may not need as much storage space (e.g., the second node may not need a separate storage device such as a flash storage device) because it may not need to store items such as operating system images and operating system drivers used for configuring or updating the operating system or other software, firmware, and/or hardware of the second node. This may provide the ability to reduce or eliminate the need for certain storage devices on many nodes and/or servers, thereby saving costs. As another example, one advantage can be reducing or eliminating the need to ship additional media (e.g., optical discs such as Compact Discs (CDs) or Digital Video Discs (DVDs)) to customers.

In some embodiments, the system allows its nodes to be configured and/or updated by accessing a set of files stored on a first node, rather than requiring additional media to store the set of files. As an additional example, as the space used by operating systems increases and space constraints in information handling systems continue to remain a concern, one advantage can be reducing or eliminating the need for large flash storage to store items such as operating system drivers, updates, or other software or files used to update or configure an operating system or other software on a node.

In some embodiments, emulating the partition may include using a Network Block Device (NBD) service. The first message may be transmitted to first controller as a request and the second message may be transmitted to the second controller as a NBD response. By using NBD responses, the second message allows the second controller to access the partition in the first node comprising the set of files by emulating the partition to configure the second node.

In some embodiments, the first controller receives a third message comprising a request using Domain Name System Service Discovery (DNS-SD) and the third message may request whether a NBD service is available. In some embodiments, the first controller transmits a fourth message comprising a response using DNS-SD and the fourth message indicates that the NBD service is available. By using DNS-SD, the system allows for nodes to discover NBD services.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

Reference is now made to the following description taken in conjunction with the accompanying drawings, wherein like reference numbers represent like parts.

FIG. 1A and FIG. 1B are block diagrams of examples of information handling systems in accordance with some embodiments of the present disclosure.

FIGS. 2-3 are flowcharts describing examples of configuring one or more nodes in an information handling system.

### DETAILED DESCRIPTION

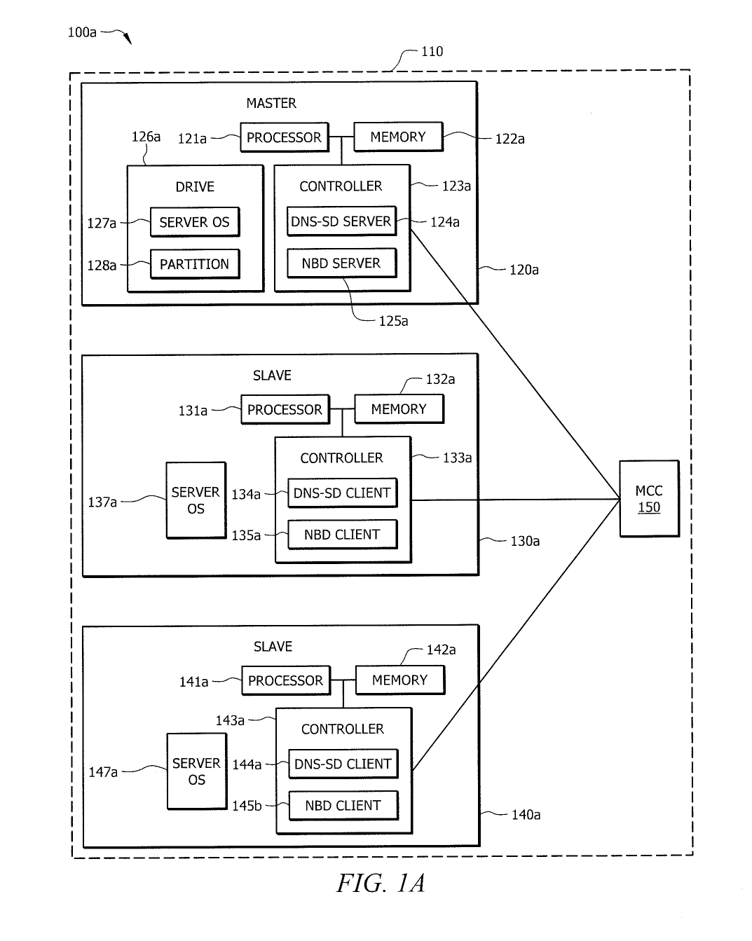

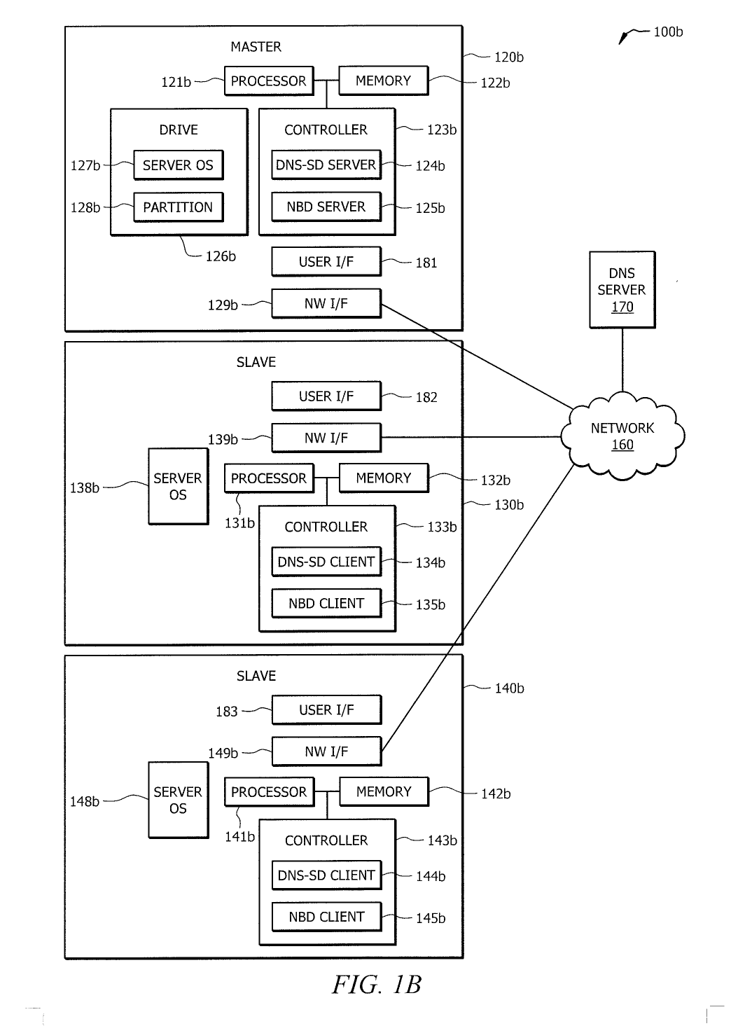

FIG. 1A and FIG. 1B are block diagrams of examples of information handling systems 100a and 100b in accordance with some embodiments of the present disclosure. In particular embodiments, components of information handling systems 100a-b may include master nodes 120a-b, slave nodes 130a-b and 140a-b housed within chassis 110. Nodes 120a-b, 130a-b, and 140a-b may be coupled to modular chassis controller 150 and/or network 160. Domain Name System (DNS) server 170 may also be coupled to network 160 in order to communicate with nodes 120a-b, 130a-b, and 140a-b. Master nodes 120a-b may include drives 126a-b, which may store operating systems 127a-b. Drives 126a-b may include one or more partitions 128a-b that are separate from operating systems 127a-b. Partitions 128a-b may store a set of files used to configured nodes 120a-b, 130a-b, and 140a-b. Systems 100a-b are operable to configure one or more master nodes 120a-b and one or more slave nodes 130a-b and 140a-b using a set of files stored in partitions 128a-b within drives 126a-b of master nodes 120a-b.

Chassis 110 of FIG. 1A, may, in some embodiments, comprise a structure configured to fully or partially enclose one or more nodes, such as nodes 120a, 130a, and 140a. For example, chassis 110 may include or may be a part of a DELL POWEREDGE VRTX chassis or a DELL POWEREDGE M1000e Blade Enclosure. Nodes 120b, 130b, and 140b, illustrated in FIG. 1B, may also be enclosed within one or more chassis 110. For example, node 120b may be in the same chassis 110 as node 130b, while node 140b may be housed in a separate chassis. Chassis 110 may also comprise modular chassis controller (MCC) 150. MCC 150 of FIG. 1A, in some embodiments, may be any system, device, or apparatus configured to facilitate management and/or control of system 100a. For example, MCC 150 may be a DELL Baseboard Management Controller (BMC). In some embodiments, MCC 150 may be configured to issue commands and/or other signals to manage and/or control system 100a and/or components of system 100a. For example, MCC 150 may facilitate communication between controllers of different nodes (e.g., controller 133a of node 130a communicating with controller 123a of node 120a). MCC 150 may comprise one or more: microprocessors, microcontrollers, digital signal processors (DSP), application specific integrated circuits (ASIC), field programmable gate arrays (FPGA), electrically erasable programmable read-only memories (EEPROM), or any suitable combination thereof. As shown in FIG. 1A, MCC 150 may be communicatively coupled to nodes 120a, 130a, and 140a. In some embodiments, MCC 150 may provide a user interface that permits a user to configure and control nodes, such as node 120a.

Nodes 120a-b, 130a-b, and 140a-b in some embodiments, may comprise a server sled, a server module, a server node, a server blade, or any suitable structure capable of housing node components (e.g., drives 126a-b, processors 121a-b, 131a-b, and 141a-b, memory modules 122a-b, 132a-b, and 142a-b, and controllers 123a-b, 133a-b, and 143a-b). Nodes 120a-b, 130a-b, and 140a-b may comprise processors 121a-b, 131a-b, and 141a-b, memory modules 122a-b, 132a-b, and 142a-b, and controllers 123a-b, 133a-b, and 143a-b. In some embodiments, nodes 120a-b may be master nodes and may include one or more drives 126a-b that store operating systems 127a-b and partitions 128a-b. It should be understood that the particular illustrated components of each node are examples only and that additional, fewer, and/or alternative components may be present. For example, node 120a may include multiple processors 121a, memory modules 122a, or drives 126a. As another example, although only node 120a (and node 120b in FIG. 1B) is designated a “master node,” there may be any number of master nodes within system 100a. For example, system 100 may include a second master node that may act as a back up master node in the event that the original master node fails or has any problems. By including a second master node, system 100 is able to continue operation without interruption, allowing time for the original master node to be repaired and/or replace.

Drives 126a-b, in some embodiments, may comprise a flash drive, a solid-state drive, a hard disk drive, or any other suitable storage device operable to store operating systems 127a-b and partitions 128a-b. Operating systems 127a-b may, in some embodiments, comprise instructions executable by processors 120a-b to operate systems 100a-b and/or nodes 120a-b after booting. Operating systems 127a-b may be stored within a separate partition of drives 126a-b than partitions 128a-b.

Partitions 128a-b, in some embodiments, may be operable to store a set of files that can be used to configure nodes 120a-b, 130a-b, and 140a-b. The set of files within partitions 128a-b may, in some embodiments, be used to perform management tasks such as firmware updates or system repair. For example, the set of files may comprise operating system images or operating system drivers. In some embodiments, the set of files stored within partitions 128a-b may be removed in order to provide space for separate sets of files used to perform other management tasks. Partitions 128a-b (e.g., a deployment partition) may be created by an administrator of systems 100a-b using, as examples, an Intelligent Platform Management Interface (IPMI) or factory provisioning software tools. In some embodiments, partitions 128a-b may be a hidden partition such that it is not visible to the host system, for example operating systems running on nodes 120a-b, but rather only visible to controllers 123a-b. For example, controllers 123a-b may detect the presence of partitions 128a-b, respectively, via a Peripheral Component Interconnect Express Vendor Defined Message (PCIe-VDM) while certain operating systems running on nodes 120a-b may not detect the presence of partitions 128a-b, respectively. Partitions 128a-b may each be a portion of a drive allocated for a particular file system. Examples of file systems deployed on partitions 128a-b are: FAT16, FAT32, NTFS, HFS, HFS+, ZFS, EXT3, EXT4, and BTRFS.

Processors 121a-b, 131a-b, and 141a-b may, in various embodiments, comprise any system, device, or apparatus operable to interpret and/or execute program instructions and/or process data. Processors 121a-b, 131a-b, and 141a-b may include one or more: microprocessors, microcontrollers, digital signal processors (DSP), application specific integrated circuits (ASIC), or another digital or analog circuitry configured to interpret and/or execute program instructions and/or process data. In some embodiments, processors 121a-b, 131a-b, and 141a-b may interpret and/or execute program instructions and/or process data stored locally (e.g., in memory modules 122a-b, 132a-b, and 142a-b, respectively). In the same or alternative embodiments, processors 121a-b, 131a-b, and 141a-b may interpret and/or execute program instructions and/or process data stored remotely.

Memory modules 122a-b, 132a-b, and 142a-b may, in various embodiments, comprise any system, device, or apparatus operable to retain and/or retrieve program instructions and/or data (e.g., computer-readable media). Memory modules 122a-b, 132a-b, and 142a-b may comprise one or more modules; such modules can include random access memory (RAM), electrically erasable programmable read-only memory (EEPROM), a PMCCIA card, flash memory, magnetic storage, opto-magnetic storage, and/or a suitable selection and/or array of volatile or non-volatile memory that retains data after power to its associated information handling system, such as information handling systems 100a-b, is powered down.

In certain embodiments, controllers 123a-b, 133a-b, and 143a-b may be implemented using any suitable device, system, or apparatus configured to monitor and/or manage one or more aspects of systems 100a-b, such as nodes 120a-b, 130a-b, and 140a-b, respectively. For example, controllers 123a-b, 133a-b, and 143a-b may include or may be a part of a DELL REMOTE ACCESS CONTROLLER (DRAC) or an INTEGRATED DELL REMOTE ACCESS CONTROLLER (iDRAC). In certain embodiments, controllers 123a-b, 133a-b, and 143a-b may enable an administrator or other user to remotely monitor and/or remotely manage one or more aspects of systems 100a-b and/or nodes 120a-b, 130a-b, and 140a-b, respectively.

In some embodiments, controllers 123a-b, 133a-b, and 143a-b may comprise Domain Name System-Service Discovery (DNS-SD) (e.g., as specified by the Internet Engineering Task Force) servers 124a-b and DNS-SD clients 134a-b and 144a-b in order to allow a host to discover a list of named instances of a desired service using DNS messages. Systems 100a-b may use any system that facilitates service discovery via the DNS-SD protocol suite, for example, AVAHI (e.g., as developed by Lennart Poettering and Trent Lloyd) and BONJOUR (e.g., as developed by APPLE INC.). To implement DNS-SD, systems 100a-b may comprise DNS-SD servers 124a-b and DNS-SD clients 134a-b and 144a-b. In some embodiments, DNS-SD clients 134a-b and 144a-b may transmit a message using DNS-SD requesting information on whether a service (e.g., a Network Block Device (NBD) service as used in the LINUX kernel) is available. For example, node 130a may use DNS-SD client 134a to engage in multicast discovery, which comprises sending a message using DNS-SD to one or more nodes 120a and 140a in system 100a to determine what services are available. In some embodiments, DNS-SD server 124a may transmit a message using DNS-SD in response indicating what services are available. The message from DNS-SD server may further include information such as the service name and the domain of the discovered service.

In some embodiments, as illustrated in FIG. 1B, system 100b comprises DNS server 170, which may comprise a server, node, or any device operable to store DNS records for a domain name and respond with answers to queries against its stored DNS records. For example, node 130a may use DNS-SD client 134a to engage in unicast discovery in which DNS-SD client 134 a sends a message using DNS-SD to DNS server 170 to determine what services are available in system 100b. DNS server 170 may transmit a message using DNS-SD in response, indicating the name and domain of available services. Unicast discovery may be advantageous in some embodiments because it may reduce the number of DNS-SD messages that DNS-SD clients 134a-b and 144a-b may need to send to discover what services are available. Further, unicast discovery may reduce the number of DNS-SD messages that DNS-SD servers 124a-b may need to send to inform DNS-SD clients 134a-b and 144a-b, respectively, what services are available. For example, DNS-SD server 124b may send a message to DNS server 170 regarding the services available on node 120b so that DNS server 170 may store that information, rather than DNS-SD server 124b responding to DNS-SD requests multiple times from various nodes 130b and 140b.

In some embodiments, controllers 123a-b, 133a-b, and 143a-b may comprise Network Block Device (NBD) servers 125a-b and NBD clients 135a-b and 145a-b to enable a device stored in a remote location (e.g., partition 128a stored on node 120a) to be recognized by a separate node (e.g., node 130a) as a device to which the node is connected. NBD components, in some embodiments, may comprise NBD servers 125a-b and NBD clients 135a-b and 145a-b. In some embodiments, NBD clients 135a-b and 145a-b may be configured to retrieve data (e.g., set of files in partitions 128a-b) by sending requests to NBD servers 125a-b, respectively. Once NBD servers 125a-b receive the request, they may respond with the requested data. In some embodiments, slave controller (e.g, controller 133b) may send a message requesting to update its node (e.g., node 130b) to DNS server 170 and/or other nodes in system 100b. In some embodiments, the second controller may use the NBD service to emulate the partition in the first node comprising the set of files to configure the second node. Using the NBD service provides one example of how the second controller may emulate the partition in the first node; other techniques of emulating the partition may be used in various embodiments.

User interfaces 181-183, illustrated in FIG. 1B, may include any instrumentality or aggregation of instrumentalities by which a user may interact with system 100b. User interfaces 181-183 may comprise a system, device, or apparatus generally operable to receive and/or transmit data to, from, or within system 100b. For example, user interfaces 181-183 may permit a user to input data and/or instructions into system 100b (e.g., via a keyboard, pointing device, touch screen, and/or other suitable means), and/or otherwise manipulate system 100b and its associated components. User interfaces 181-183 may also permit system 100b to communicate data to a user, e.g., by means of a display device. For example, user interfaces 181-183 may include a touch panel that may include circuitry for enabling touch functionality in conjunction with a display. In some embodiments, an administrator of system 100b may utilize user interfaces 181-183 to store the set of files in partition 128b of drive 126b.

Network 160, illustrated in FIG. 1B, in some embodiments, may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network 160 and its various components may be implemented using hardware, software, or any combination thereof. Network 160 is configured such that nodes 120b, 130b, and 140b may communicate with or access information in information handling system 100b, or particular components of information handling system 100b, such as DNS server 170. Although FIG. 1B illustrates one network 160, it should be understood that any number of networks may be included.

In some embodiments, network interfaces 129b, 139b, and 149b, illustrated in FIG. 1B, may be any suitable system, apparatus, or device operable to serve as an interface between nodes 120b, 130b, and 140b and network 160. As an example and not by way of limitation, network interfaces 129b, 139b, and 149b may include a network interface controller or card (NIC) or network adapter for communicating with an Ethernet or other wireline network or a wireless NIC (WNIC) or wireless adapter for communicating with a wireless network, such as a WI-FI network. Network interfaces 129b, 139b, and 149b may enable nodes 120b, 130b, and 140b to communicate over network 160 using a suitable transmission protocol and/or standard, including, but not limited to, transmission protocols and/or standards enumerated above with respect to the discussion of network 160. Network interfaces 129b, 139b, and 149b may be communicatively coupled to controllers 123b, 133b, and 143b, respectively, by a communication medium, such as a Peripheral Component Interconnect (PCI) bus, PCI-Express (PCIe) bus, PCIe Vendor Defined Message (VDM) HyperTransport (HT) bus, System Management Bus (SMBus), or any suitable bus architecture.

In some embodiments, controllers 123a-b are configured to access a set of files stored in partitions 128a-b and configure nodes 120a-b, respectively, based on the set of files. Controllers 123a-b may be further configured to receive a DNS-SD message requesting whether a NBD service is available. In some embodiments, as illustrated in FIG. 1A, controller 123a may receive the DNS-SD message sent from one or more slave controllers 133a and 143a. Controller 123a may be further configured to send a response using DNS-SD indicating that NBD service is available. In certain embodiments, as illustrated in FIG. 1B, controller 123b may send information to DNS server 170 via network 160, such that DNS server 170 responds to requests from controllers 133b and 143b with information regarding an available NBD service. Controllers 123a-b may be further configured to receive a NBD request from slave controllers 133a-b and 143a-b requesting access to drives 126a-b. Controllers 123a-b may be configured to transmit a NBD response allowing slave controllers 133a-b and 143a-b access to drives 126a-b and transmitting the set of files stored within partitions 128a-b, respectively.

In some embodiments, controllers 133a-b and 143a-b are configured to: determine that nodes 130a-b and 140a-b require a management task to be performed (e.g., installing operating system, updating operating system with OS drivers), send a DNS-SD request to controllers 123a-b requesting whether a NBD service is available, and receive a DNS-SD response from controllers 123a-b indicating that a NBD service is available. In some embodiments, as illustrated in FIG. 1B, controllers 133b and 143b may send a DNS-SD request to DNS server 170 and receive a response from DNS server 170 indicating the nodes that may offer a NBD service. Controllers 133a-b and 143a-b may be further configured to send a NBD request to controllers 123a-b, receive a NBD response sent from controllers 123a-b allowing access to drives 126a-b, emulate partitions 128a-b to perform the necessary management task for nodes 130a-b and 140a-b, and receive the set of files stored in partitions 128a-b.

In some embodiments, with reference to FIG. 1A, system 100a may operate as follows. Controller 123a may detect the presence of partition 128a within drive 126a and determine that a management task (e.g., firmware update, installation of an operating system, updating an operating system, updating a driver) needs to be performed on node 120a. Controller 123a may access the set of files (e.g., an operating system image) within partition 128a in order to configure and/or update node 120a. Slave controllers 133a and 143a may determine that a management task (e.g., installation of an operating system) needs to be performed on nodes 130a and 140a. Controllers 133a and 143a may send a DNS-SD message using DNS-SD clients 134a and 144a, through MCC 150, to master controller 123a. The DNS-SD message for example, may request whether a NBD service is available on node 120a. Controller 123a, after receiving the DNS-SD message from controllers 133a and 143a may determine that a NBD service is available and send a DNS-SD response to controllers 133a and 143a indicating an NBD service is available. Slave controllers 133a and 143a may receive the DNS-SD message, which includes information regarding the available NBD service, at DNS-SD clients 134a and 144a. Controllers 133a and 143a may use NBD clients 135a and 145a to send a NBD request message requesting access to a set of files stored within partition 128a, so that nodes 130a and 140a may be configured and/or updated. Controller 123a may receive the NBD request message at NBD server 125a and send a response message indicating that controllers 133a and 143a have access to partition 128a. Controllers 133a and 143a may use NBD clients 135a and 145a to emulate partition 128a to access the set of files stored on partition 128a and update and/or configure nodes 130a and 140a.

In some embodiments, with reference to FIG. 1B, system 100b may operate as follows. Master controller 123b may detect the presence of partition 128b comprising a set of files configured to update and/or configure node 120b. Controller 123b may access the set of files in order to update and configure node 120b. Slave controllers 133b and 143b, may determine that a management task (e.g., installing an operating system) needs to be performed on nodes 130b and 140b. Controllers 133b and 143b may use DNS-SD clients 134b and 144b to send a multicast message to other nodes within system 100b. For example, controller 143b may use network 160 to send a DNS-SD request message to controllers 123b and 133b. Continuing the example, controller 133b of slave node 130b may not respond to controller 143b because it does not have a NBD service available, while controller 123b would respond to controller 143b indicating that it has a NBD service available and giving additional information about the NBD server. In some embodiments, controller 143b may utilize unicast discovery by sending a DNS-SD message to DNS server 170 through network 160. DNS server 170 may receive the DNS-SD message from controller 143b and determine information regarding an available NBD service (e.g., that controller 123b has a NBD service available). DNS-SD server 170 may send a response DNS-SD message to controller 143b including the information regarding the available NBD service. Controller 143b may send a NBD request to controller 123b, knowing that controller 123b has a NBD service available, either because controller 123b responded to slave controller 143b itself or because slave controller 143b received this information from DNS server 170. Controller 123b may receive the NBD request at NBD server 125b and send a NBD response indicating that controller 143b may access partition 128b. Controller 123b then transmits the set of files stored within partition 128b. Controller 143b may emulate partition 128b that stores the set of files in order to update and/or configure its host system node 140b.

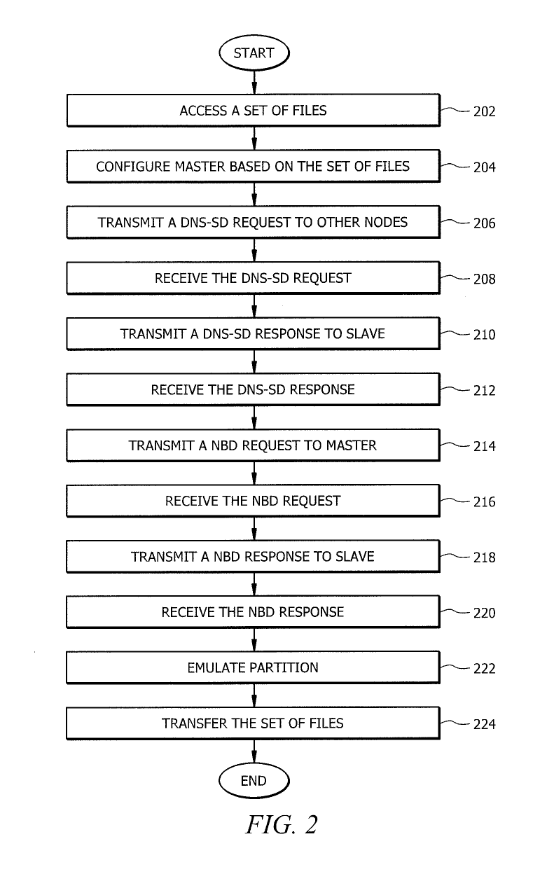

FIG. 2 illustrates a flowchart describing an example of configuring one or more nodes in an information handling system. To illustrate examples of configuring one or more nodes, the steps of FIG. 2, described below, discuss some of the components of FIG. 1A, although other components not illustrated in FIG. 1A may be used. At step 202, in some embodiments, controller 123a accesses a set of files stored within partition 128a. The set of files may include data that allows controller 123a to update and/or configure node 120a. For example, the set of files may include the image of an operating system or operating system drivers. At step 204, in some embodiments, controller 123a configures master node 120a based on the set of files accessed in step 202 (e.g., configuring or updating the operating system or other software, firmware, and/or hardware of the master node).

At step 206, in some embodiments, controller 143a transmits DNS-SD request messages to other nodes in system 100a. Controller 143a may use MCC 150 in order to transmit the message to the other nodes stored in chassis 110. Controller 143a may transmit the DNS-SD messages to any number of nodes within system 100a. For example, controller 143a may send a DNS-SD message to each node within the system, such as node 130a and node 120a. As another example, controller 143a may send a DNS-SD request message to only one other node in the system such as node 120a.

At step 208, in some embodiments, controllers 123a and 133a of nodes 120a and 130a, respectively, may receive the DNS-SD request sent from controller 143a. Controller 133a, in some embodiments may receive the DNS-SD request message and send no response because it does not have a NBD service available. As another example, at step 210 controller 123a may transmit a DNS-SD response to slave controller 143a indicating that it has a NBD service available, which may be received by controller 143a in step 212. In receiving the DNS-SD response, controller 143a now has information (e.g., domain) of the NBD service that is available.

At step 214, in some embodiments, controller 143a may transmit a NBD request, which may be received by controller 123a at step 216. The NBD request may be sent using MCC 150 and may request access to the set of files stored in partition 128a. At step 218, in some embodiments, controller 123a may transmit a NBD response message to slave controller 143a, which slave controller 143a may receive at step 220. The response may include information indicating that controller 143a has access to partition 128a of drive 126a and the set of files stored within partition 128a. If controller 123a initiates the NBD process in this way, then steps 214, 216, and 218 may be omitted. This allows system 100a to reduce the number of messages being sent between nodes 120a, 130a, and 140a.

At step 222, in some embodiments, controller 143a may emulate partition 128a in order to receive the set of files from controller 123a. By emulating partition 186a, controller 143a is able to update and/or configure node 140a even though the set of files are not stored within the host system of node 140a, but rather stored remotely within node 120a. Emulating may include causing the node to detect the drive or partition as if the drive or partition were connected to the node. This may reduce the amount of required storage space within node 140a while still allowing management tasks, such as loading an operating system or updating an operating system using operating system drivers, to be performed. In some embodiments, controller 143a may emulate partition 128a using the NBD service, although other suitable protocols, programs, or services may be used. At step 224, in some embodiments, controller 123a transfers the set of files stored within partition 128a to controller 143a. Controller 143a, by continuing to emulate partition 128a, may update and configure node 140a. After this, the method ends.

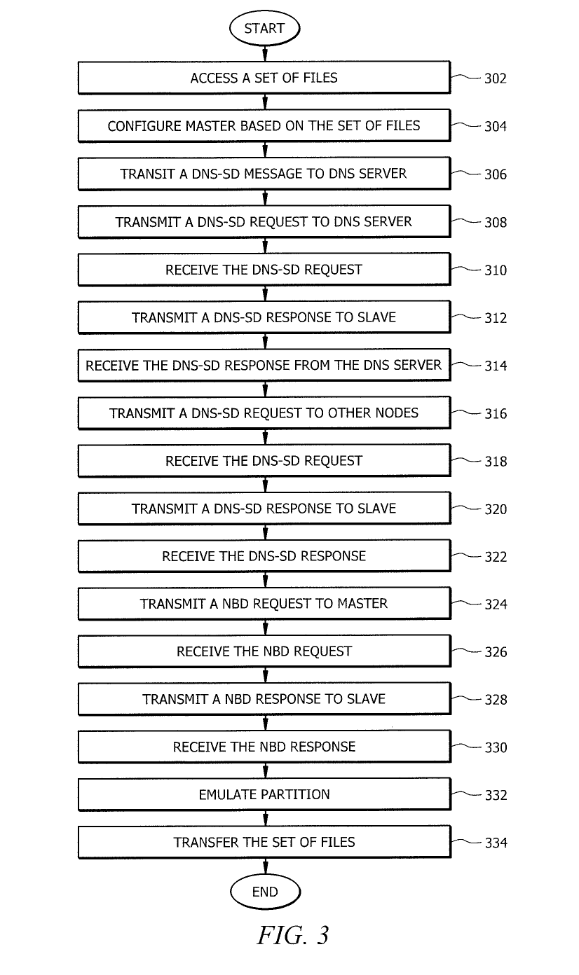

FIG. 3 illustrates a flowchart describing an example of configuring one or more nodes in information handling system 100b. To illustrate examples of configuring one or more nodes, the steps of FIG. 3, described below, discuss components of FIG. 1B, although other components not illustrated in FIG. 1B may be used. At step 302, in some embodiments, controller 123b accesses a set of files stored within partition 128b and, in step 304, configures master node 120a based on the set of files. In some embodiments, steps 302-304 of the method illustrated in FIG. 3 can be performed using one or more of the techniques discussed above with respect to steps 202-204 of FIG. 2.

At step 306, in some embodiments, controller 123b may transmit a DNS-SD message to DNS server 170 via network 160 in order to advertise the services that node 120b has available. By sending this information to DNS server 170, controller 123b can allow controllers 133b and 144b to use the unicast method of service discovery, rather than the multicast method of service discovery. At step 308, controllers 133b and 143b may transmit a DNS-SD message to DNS server 170 requesting information regarding available services (e.g., NBD service) within system 100b and DNS server 170 receives the message at step 310. By engaging in unicast discovery, controller 133b only needs to send one message to DNS server 170, rather than sending a DNS-SD message to each of the other nodes (e.g., nodes 120b, 140b) in system 100b. In response to receiving the DNS-SD request at step 310, DNS server 170 may transmit a DNS-SD response indicating information regarding the requested service at step 312. At step 314, controller 123b may receive the message regarding the requested service.

In some embodiments, controller 133b may engage in multicast discovery, which includes sending DNS-SD messages to a plurality of nodes within system 100b. At step 316, in some embodiments, controller 133b may send DNS-SD requests to other nodes (e.g., 120b and 140b) in system 100b. For example, controller 133b may send a DNS-SD message indicating whether a NBD service is available that would be received by controllers 143b and 123b at step 318, in some embodiments. Continuing the example, controller 143b would send no response because it does not provide a NBD service in this example, while controller 123b would send a DNS-SD response, at step 320, indicating information about the NBD service available through node 120b. At step 322, in some embodiments, controller 133b receives the DNS-SD response from controller 123b. In some embodiments, steps 316-322 of the method illustrated in FIG. 3 may be performed using one or more of the techniques discussed above with respect to steps 206-212 of FIG. 2. In some embodiments, controller 133b may use multicast discovery instead of, or in addition to, unicast discovery. If engaging in unicast discovery, steps 316-322 may be omitted from the method shown in FIG. 3. If engaging in multicast discovery, steps 306-314 may be omitted from the method illustrated in FIG. 3.

At step 324, in some embodiments, controller 133b transmits a NBD request, which is received by controller 123b at step 326. In response to the NBD request, controller 123b, in some embodiments, transmits a NBD response at step 328 indicating that controller 133b has access to drive 126b, and the response is received by controller 133b at step 330. At step 332, in some embodiments, controller 143b may emulate partition 128b in order to receive the set of files that are transferred by controller 123b at step 334. Then the method ends. In some embodiments, steps 324-334 of the method illustrated in FIG. 3 can be performed using one or more of the techniques discussed above with respect to steps 214-224 of FIG. 2.

For the purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device, and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media, such as a direct access storage device (e.g., a hard disk drive or floppy disk); a sequential access storage device (e.g., a tape disk drive); a compact disk; CD-ROM; DVD; random access memory (RAM); read-only memory (ROM); electrically erasable programmable read-only memory (EEPROM); and/or flash memory; as well as communications media, such as wires, optical fibers, microwaves, radio waves, and other electromagnetic and/or optical carriers; and/or any combination of the foregoing.

Modifications, additions, or omissions may be made to the systems described herein without departing from the scope of the disclosure. Although this disclosure describes and illustrates a particular information handling system having a particular number of particular components in a particular arrangement, this disclosure contemplates any suitable information handling system having any suitable number of any suitable components in any suitable arrangement. For example, information handling systems 100a-b may include any number of nodes 120a-b, 130a-b, and 140a-b, chassis 110, controllers 123a-b, 133a-b, 143a-b, processors 121a-b, 131a-b, 141a-b, memories 122a-b, 132a-b, 142a-b, DNS servers 170, and networks 160. The components may be integrated or separated. Moreover, the operations may be performed by more, fewer, or other components. Additionally, the operations may be performed using any suitable logic comprising software, hardware, and/or other logic. Further, the steps may be combined, modified, or deleted where appropriate, and additional steps may be added. Additionally, the steps may be performed in any suitable order without departing from the scope of the present disclosure. While discussed as controllers (e.g., 123, 133, 143), their components, and DNS server 170 performing the steps, any suitable component of information handling system 102 may perform one or more of the steps.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. An information handling system, comprising:
a first controller, a first node comprising the first controller, the first controller configured to:
access a set of files, the set of files stored within a first partition of a drive of the first node;
configure the first node based on the set of files;
receive a first message sent from a second controller, the first message requesting access to the drive in the first node comprising the set of files, the second controller within a second node, the second node being different than the first node;
in response to receiving the first message, transmit a second message to the second controller, the second message allowing the second controller to access the drive in the first node comprising the set of files by emulating the first partition to configure the second node; and
after transmitting the second message, transfer the set of files to the second controller.

2. The system of claim 1, wherein the first controller is further configured to:
receive a third message comprising a request using Domain Name System Service Discovery (DNS-SD), the third message requesting whether a Network Block Device (NBD) service is available;
transmit a fourth message comprising a response using Domain Name System Service Discovery (DNS-SD), the fourth message indicating that the Network Block Device (NBD) service is available;
wherein the first controller comprises a Network Block Device server;
wherein the second controller comprises a Network Block Device client;
wherein the first message comprises a Network Block Device (NBD) request;
wherein the second message comprises a Network Block Device (NBD) response; and
wherein transferring the set of files to the second controller comprises the Network Block Device server transferring the set of files to the Network Block Device client.

3. The system of claim 1, wherein the controller is further configured to:
receive a third message, the third message comprising a request using Domain Name System Service Discovery (DNS-SD), the third message requesting whether a Network Block Device (NBD) service is available; and
transmit a fourth message, the fourth message comprising a response using Domain Name System Service Discovery (DNS-SD), the third message indicating that the Network Block Device (NBD) service is available.

4. The system of claim 1, wherein:
the first message sent from the second controller comprises a Network Block Device (NBD) request; and
the second message comprises a Network Block Device (NBD) response.

5. The system of claim 1, wherein:
the first controller comprises a Network Block Device server;
the second controller comprises a Network Block Device client; and
transferring the set of files to the second controller comprises the Network Block Device server transferring the set of files to the Network Block Device client.

6. The system of claim 1, wherein an operating system of the first node is stored on a second partition of the drive, the second partition being different than the first partition.

7. The system of claim 6, wherein the first partition is not accessible to the operating system of the first node.

8. An method, comprising:
accessing, using a first controller, a set of files, the set of files stored within a first partition of a drive of a first node;
configuring the first node based on the set of files;
receiving a first message sent from a second controller, the first message requesting access to the drive in the first node comprising the set of files, the second controller within a second node, the second node being different than the first node;
in response to receiving the first message, transmitting a second message to the second controller, the second message allowing the second controller to access the drive in the first node comprising the set of files by emulating the first partition to configure the second node; and
after transmitting the second message, transferring the set of files to the second controller.

9. The method of claim 8, further comprising:
receiving a third message comprising a request using Domain Name System Service Discovery (DNS-SD), the third message requesting whether a Network Block Device (NBD) service is available;
transmitting a fourth message comprising a response using Domain Name System Service Discovery (DNS-SD), the fourth message indicating that the Network Block Device (NBD) service is available;
wherein the first controller comprises a Network Block Device server;
wherein the second controller comprises a Network Block Device client;
wherein the first message comprises a Network Block Device (NBD) request;
wherein the second message comprises a Network Block Device (NBD) response; and
wherein transferring the set of files to the second controller comprises the Network Block Device server transferring the set of files to the Network Block Device client.

10. The method of claim 8, further comprising:
receiving a third message, the third message comprising a request using Domain Name System Service Discovery (DNS-SD), the third message requesting whether a Network Block Device (NBD) service is available; and
transmitting a fourth message, the fourth message comprising a response using Domain Name System Service Discovery (DNS-SD), the third message indicating that the Network Block Device (NBD) service is available.

11. The method of claim 8, wherein:
the first message sent from the second controller comprises a Network Block Device (NBD) request; and
the second message comprises a Network Block Device (NBD) response.

12. The method of claim 8, wherein:
the first controller comprises a Network Block Device server;
the second controller comprises a Network Block Device client; and
transferring the set of files to the second controller comprises the Network Block Device server transferring the set of files to the Network Block Device client.

13. The method of claim 8, wherein an operating system of the first node is stored on a second partition of the drive, the second petition being different than the first petition, the first partition not being accessible to the operating system of the first node.

14. A non-transitory computer-readable medium including computer-executable instructions encoded in the computer-readable medium, the instructions, when executed by a processor, executable to:
access a set of files, the set of files stored within a first partition of a drive of the first node;
configure the first node based on the set of files;
receive a first message sent from a second controller, the first message requesting access to the drive in the first node comprising the set of files, the second controller within a second node, the second node being different than the first node;
in response to receiving the first message, transmit a second message to the second controller, the second message allowing the second controller to access the drive in the first node comprising the set of files by emulating the first partition to configure the second node; and
after transmitting the second message, transfer the set of files to the second controller.

15. The non-transitory computer-readable medium of claim 14, the computer-executable instructions, when executed by a processor, further executable to:
receive a third message comprising a request using Domain Name System Service Discovery (DNS-SD), the third message requesting whether a Network Block Device (NBD) service is available;
transmit a fourth message comprising a response using Domain Name System Service Discovery (DNS-SD), the fourth message indicating that the Network Block Device (NBD) service is available;
wherein the first controller comprises a Network Block Device server;
wherein the second controller comprises a Network Block Device client;
wherein the first message comprises a Network Block Device (NBD) request;
wherein the second message comprises a Network Block Device (NBD) response; and
wherein transferring the set of files to the second controller comprises the Network Block Device server transferring the set of files to the Network Block Device client.

16. The non-transitory computer-readable medium of claim 14, the computer-executable instructions, when executed by a processor, further executable to:
receive a third message, the third message comprising a request using Domain Name System Service Discovery (DNS-SD), the third message requesting whether a Network Block Device (NBD) service is available; and
transmit a fourth message, the fourth message comprising a response using Domain Name System Service Discovery (DNS-SD), the third message indicating that the Network Block Device (NBD) service is available.

17. The non-transitory computer-readable medium of claim 14, wherein:
the first message sent from the second controller comprises a Network Block Device (NBD) request; and
the second message comprises a Network Block Device (NBD) response.

18. The non-transitory computer-readable medium of claim 14, wherein:
the first controller comprises a Network Block Device server;
the second controller comprises a Network Block Device client; and
transferring the set of files to the second controller comprises the Network Block Device server transferring the set of files to the Network Block Device client.

19. The non-transitory computer-readable medium of claim 14, wherein an operating system of the first node is stored on a second partition of the drive, the second partition being different than the first partition.

20. The non-transitory computer-readable medium of claim 19, wherein the first partition is not accessible to the operating system of the first node.
